(19) United States
(12) Patent Application Publication
(10) Pub. No.: US 2025/0291352 A1
(43) Pub. Date: Sep. 18, 2025

(54) POSTURE CONTROL METHOD, POSTURE CONTROL DEVICE, AND STORAGE MEDIUM

(71) Applicant: HONDA MOTOR CO., LTD., Tokyo (JP)

(72) Inventors: Daiki Morozumi, Wako-shi (JP); Tadashi Sumioka, Wako-shi (JP); Hirofumi Shin, Wako-shi (JP)

(21) Appl. No.: 19/073,072

(22) Filed: Mar. 7, 2025

(30) Foreign Application Priority Data
Mar. 14, 2024 (JP) 2024-040334

(51) Int. Cl. G05D 1/49; B62D 57/032; G05D 109/12

(52) U.S. Cl. CPC G05D 1/49; B62D 57/032; G05D 2109/12

(57) ABSTRACT

A posture control method is a posture control method of a non-linear inverted pendulum model, of which a height of a center of gravity is variable, and a trajectory of the center of gravity is an energy conserving system, using a control device, the posture control method including: obtaining a conservation energy function on the basis of a measured value of the center of gravity; converting the conservation energy function into a curve function; and calculating a set of eigenvectors through approximation as a convergent component and a divergent component without iterative calculation of a controllable area in a phase plot of the converted curve function and feeding back the convergent component and the divergent component that have been calculated.

### CROSS-REFERENCE TO RELATED APPLICATION

Priority is claimed on Japanese Patent Application No. 2024-040334, filed Mar. 14, 2024, the content of which is incorporated herein by reference.

### BACKGROUND OF THE INVENTION

### Field of the Invention

The present invention relates to a posture control method, a posture control device, and a storage medium.

### Description of Related Art

In walking control of bipedal walking robots, by using a simplified model (a linear inverted pendulum (LIP)) such as a constant-height inverted pendulum, various techniques have been proposed. A constant-height inverted pendulum motion can be considered by dividing it into a divergent component (Divergent Component of Motion (DCM)) and a convergent component (Convergent Component of Motion (CCM)). Particularly, the divergent component, theoretically, can alleviate boundary conditions by ensuring the continuity of gait, and a stabilizable range can be analytically derived by performing divergent component feedback control, and thus a regulator that is the best in terms of stabilization can be built, and thus the divergent component is widely used.

The condition that the height is constant is an unrealistic constraint when running or hopping is caused to be performed, and thus control techniques in a height-variable non-linear inverted pendulum model have been researched (for example, see Non-Patent Document 1 represented below).
[Non-Patent Document 1] Ko Yamamoto, Takumi Kamioka, et al., ‘Survey on model-based biped motion control for humanoid robots’, ADVANCED ROBOTICS (2020), Volume 34, 2020—Issue 21-22: Special Issue on Humanoid Robotics, p 1353-1369, 2020

### SUMMARY OF THE INVENTION

However, in a conventional technology, in accordance with the height being variable, it becomes difficult to obtain an analytical solution, and thus it is necessary to obtain a solution numerically through iterative calculations.

An aspect according to the present invention is in consideration of the problems described above, and an object thereof is to provide a posture control method, a posture control device, and a storage medium capable of controlling a height-variable non-linear inverted pendulum without performing iterative calculation.

In order to achieve related objects by solving the problems described above, the present invention employs the following aspects.

(1) A posture control method according to one aspect of the present invention is a posture control method of a non-linear inverted pendulum model, of which a height of a center of gravity is variable, and a trajectory of the center of gravity is an energy conserving system, using a control device, the posture control method including: obtaining a conservation energy function on the basis of a measured value of the center of gravity; converting the conservation energy function into a curve function; and calculating a set of eigenvectors through approximation as a convergent component and a divergent component without iterative calculation of a controllable area (for example, an area in which an input is not saturated) in a phase plot of the converted curve function and feeding back the convergent component and the divergent component that have been calculated.

(2) In the aspect (1) described above, the trajectory of the center of gravity may be an ellipse or a hyperbola, and the control device may linearize the set of eigenvectors around the origin of a phase plot of the curve function of the ellipse and feed back the linearized set of eigenvectors as a convergent component and a divergent component.

(3) In the aspect (1) described above, the curve function may be a hyperbolic function, and the control device may feed back an asymptote of a curve drawn by the hyperbolic function as a convergent component and a divergent component of the non-linear inverted pendulum model.

(4) In any one of the aspects (1) to (3) described above, the conservation energy function may be set using a parametric variable.

(5) In the aspect (2) described above, the linearized set λ=±ω′ of eigenvectors that is the convergent component and the divergent component may be obtained from the following equation.

$$\frac{d}{dt} [ \begin{matrix}θ \\ \dot{θ}\end{matrix} ] = [ \begin{matrix}0 & 1 \\ {w}^{′2} & 0\end{matrix} ] [ \begin{matrix}θ \\ \dot{θ}\end{matrix} ]$$

(6) In the aspect (3) described above, θ is a state quantity of an inverted pendulum expressed in a parametric variable, θ^{⋅} is a time derivative of θ, g is a gravitational acceleration, C is a divergent component denominator variable, X(θ) is a function, Ω(θ) is a function, and x is a position in a movement direction, and the asymptote may be obtained using the following equation.

$$\dot{θ} = \pm \sqrt{\frac{gX ( θ )}{C {θ}^{2}}} θ = \pm Ω ( θ ) x$$

(7) In the aspect (1) described above, K_{P} is a gain, K_{V} is a gain, θ is a state quantity of an inverted pendulum expressed in a parametric variable, θ^{⋅} is a time derivative of θ, τ_{θ} is an input to a system, and ω is a slope of the divergent component and is K_{P}/K_{V}, and the control device may perform the feedback on the basis of the following equation.

$${τ}_{θ} = {K}_{P} θ + {K}_{V} \dot{θ} = {K}_{P} ( θ + \frac{1}{ω} \dot{θ} )$$

(8) In the aspect (1) described above, K_{P} is a gain, K_{V} is a gain, θ is a state quantity of an inverted pendulum expressed in a parametric variable, θ^{⋅} is a time derivative of θ, τ_{θ} is an input to a system, ω is a slope of the divergent component and is K_{P}/K_{V}, and Ω(θ) is a function of θ, and the control device may perform the feedback on the basis of the following equation.

$${τ}_{θ} = {K}_{P} θ + {K}_{V} \dot{θ} = {K}_{P} ( θ + \frac{1}{Ω ( θ )} \dot{θ} )$$

(9) A posture control device according to one aspect of the present invention is a posture control device controlling a posture of a mobile body, the posture control device including: a non-linear inverted pendulum model of which a height of a center of gravity is variable, and a trajectory of the center of gravity is an energy conserving system; a function calculating unit obtaining a conservation energy function on the basis of a measured value of the center of gravity; a conversion unit converting the conservation energy function into a curve function; and a feedback unit calculating a set of eigenvectors through approximation as a convergent component and a divergent component without iterative calculation of a controllable area (for example, an area in which an input is not saturated) in a phase plot of the converted curve function and feeding back the convergent component and the divergent component that have been calculated.

(10) A storage medium according to one aspect of the present invention stores a program causing a computer of a control device, which controls a posture of a mobile body, having a non-linear inverted pendulum model of which a height of a center of gravity is variable, and a trajectory of the center of gravity is an energy conserving system, to: obtain a conservation energy function on the basis of a measured value of the center of gravity; convert the conservation energy function into a curve function; and calculate a set of eigenvectors through approximation as a convergent component and a divergent component without iterative calculation of a controllable area (for example, an area in which an input is not saturated) in a phase plot of the converted curve function and feed back the convergent component and the divergent component that have been calculated.

According to the aspects (1) to (10) described above, a height-variable non-linear inverted pendulum can be controlled without performing iterative calculation. According to the aspects (1) to (10) described above, a divergent component can be derived from an energy function without performing iterative calculation.

### BRIEF DESCRIPTION OF THE DRAWINGS

FIG. 1 is a diagram for describing a phase plane, a divergent component, and a convergent component.

FIG. 2 is a diagram illustrating a configuration example of a robot control system according to an embodiment.

FIG. 3 is a diagram for describing a height-fixed inverted pendulum model and a height-variable inverted pendulum model.

FIG. 4 is an image diagram of a phase plot obtained in a case in which a divergent component of a height-variable inverted pendulum model is considered using a conventional technology.

FIG. 5 is a diagram for describing linearization of a divergent component and a convergent component.

FIG. 6 is a schematic block diagram of a stabilization control system.

FIG. 7 is a diagram for describing symbols used in a state equation of an inverted pendulum.

FIG. 8 is a phase plot obtained when stabilization control is performed by appropriately determining k_{P} and K_{V}.

FIG. 9 is a flowchart of a process performed by a control device according to a first embodiment.

FIG. 10 is a diagram illustrating an example of a phase plot of a non-linear system.

FIG. 11 is a phase plot in which the horizontal axis is θ₁ (rad/s), and the vertical axis is θ^{⋅}₁ (rad/s).

FIG. 12 is a diagram illustrating an example of a phase plot obtained in a case in which linearization is performed near (θ, θ^{⋅})=(0, 0) in accordance with an embodiment.

FIG. 13 is a diagram illustrating an example of a phase plot obtained in a case in which a gain is set using a non-linear divergent component according to an embodiment.

FIG. 14 is a flowchart of a process performed by a control device according to an embodiment.

### DETAILED DESCRIPTION OF THE INVENTION

Hereinafter, an embodiment of the present invention will be described with reference to the drawings. In drawings used in the following description, in order to allow each member to have a recognizable size, the scales of respective members are appropriately changed.

In all the drawings used for describing an embodiment, the same reference signs will be used for members having the same function, and repetitive description will be omitted.

“On the basis of XX” in description in the present application means “at least on the basis of XX”, and a case of being on the basis of other elements in addition to XX is included therein. “On the basis of XX” is not limited to a case in which XX is directly used, and a case of being on the basis of a result obtained by performing an arithmetic operation or processing on XX is also included therein. “XX” is an arbitrary element (for example, arbitrary information).

### [Overview]

In this embodiment, a walkable robot derives a divergent component from an energy function without performing iterative calculation for a height-variable non-linear inverted pendulum. In this embodiment, by using a model that is able to derive a curved trajectory including a straight line, as in a conventional technology, in order to obtain an analytical solution of a divergent component, the trajectory is controlled without generating the trajectory using a piecewise linearization model.

### [Overview of Control Using Inverted Pendulum Model and Description of Terms]

First, terms, principles, and the like used in this embodiment will be schematically described.

As a walking model of a robot, for example, an inverted pendulum model in which the center of gravity is above a pivot point is known. In such a model, for example, the center of gravity is set on a body, and a pivot point is set on the sole of the feet. In a robot having foot parts, a zero moment point (ZMP) is frequently used in trajectory planning and control. The ZMP is synonymous with the center of pressure of the floor pressure.

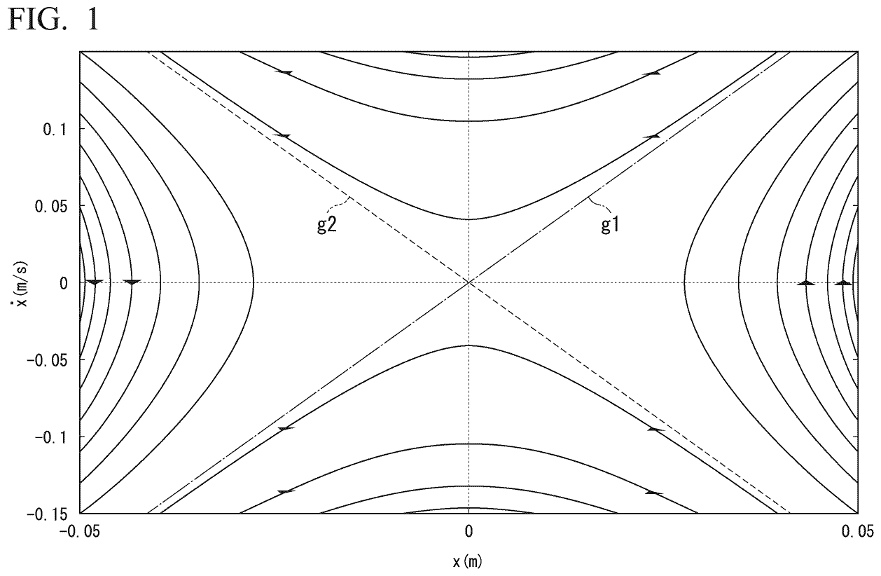

In a conventional technology, the height of the center of gravity accompanied with walking is maintained to be constant using a leg strength f. In an inverted pendulum motion having a constant height, the equation of motion can be established by fixing the ZMP at the origin. In this equation of motion, the time derivative of the center of gravity position is a velocity, and the time derivative of the velocity is an acceleration. A vector such as a position or a velocity representing an instantaneous state of a target will be referred to as a state vector. For example, as in FIG. 1, in this state vector, a plane in which the position x (m) of the center of gravity is represented in the horizontal axis, and a velocity x^{⋅} (m/s) of the center of gravity is represented in the vertical axis will be referred to as a phase plane. FIG. 1 is a diagram for describing a phase plane, a divergent component, and a convergent component. In FIG. 1, dotted line g1 represents an asymptote (division line) of a divergent component (DCM), and dotted line g2 represents an asymptote (division line) of a convergent component (CCM). The divergent component is represented as x+(x^{⋅}/ω). ω is the slope of the divergent component, ω=√(g/b), b is a height from the floor to the center of gravity, and g is a gravitational acceleration (for example, see Reference Document 1).
Reference Document 1: Shuji Kajita (Editor), “Humanoid Robots (Revised 2nd Edition)”, Ohm Co., p 132-219, 2020

### [Robot Control System]

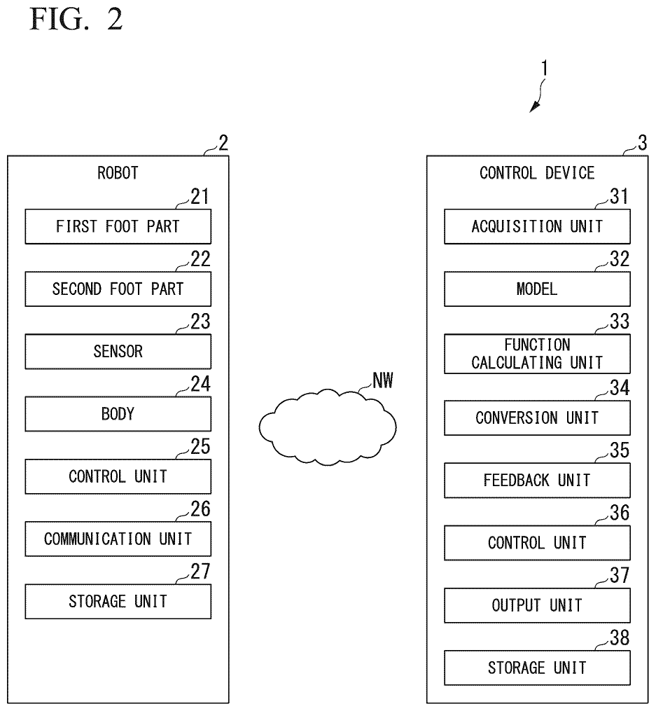

Next, a configuration example of the robot control system 1 according to this embodiment will be described. FIG. 2 is a diagram illustrating a configuration example of a robot control system according to this embodiment.

The robot control system 1, for example, includes a robot 2 and a control device 3. The control device 3 may be included in the robot 2.

The robot 2, for example, includes a first foot part 21, a second foot part 22, a sensor 23, a body 24, a control unit 25, a communication unit 26, and a storage unit 27. The robot 2 includes a power supply and may include an arm, a head part, and the like.

The control device 3, for example, includes an acquisition unit 31, a model 32, a function calculating unit 33, a conversion unit 34, a feedback unit 35, a control unit 36, an output unit 37, and a storage unit 38.

### (Robot)

The robot 2, for example, is a bipedal walking robot. The robot 2 performs transmission/reception of information to/from the control device 3 through a wired or wireless network NW.

In each of the first foot part 21 and the second foot part 22, a crotch is connected to a body through a joint. Each of the first foot part 21 and the second foot part 22, for example, includes a thigh, a lower leg, and a foot in a lower limb and includes a joint in each of a hip, a knee, and an ankle. In each joint, an encoder (a sensor 23) is included. Each of the first foot part 21 and the second foot part 22 includes an actuator in the joint.

The sensor 23, for example, is an encoder mounted in each joint, an acceleration sensor mounted in a leg or the like, a force sensing sensor, a gyro sensor, or the like. The sensor 23 detects, for example, the posture of a waist link, a ground reaction force, a joint angle, and the like.

The first foot part 21 and the second foot part 22 are connected to the body 24. An arm and a head part may be connected to the body 24.

The control unit 25 outputs a detection result detected by the sensor 23 to the control device 3 through the communication unit 26. The control unit 25 controls operations of foot parts (the first foot part 21 and the second foot part 22) in accordance with a control value or a control instruction output by the control device 3 or a drive signal.

The communication unit 26 outputs a detection value output by the control unit 25 to the control device 3. The communication unit 26 acquires a control value or a control instruction output by the control device 3 or a drive signal.

The storage unit 27 stores programs, thresholds, numerical expressions, and the like used in control and the like by the control unit 25.

### (Control Device)

The control device 3, for example, is a personal computer or the like.

The acquisition unit 31 acquires a detection value output by the robot 2. The acquisition unit 31 may be configured to acquire an operation instruction and the like that have been set or input by an operator of the robot 2.

The model 32, for example, is a non-linear inverted pendulum model of which a trajectory is an energy conserving system.

The function calculating unit 33 obtains a ZMP position, a center of gravity position, and the like using a detection result detected by the sensor 23. The function calculating unit 33 obtains an energy function of the conservation system using the ZMP position, the center of gravity position, and the like that have been obtained and the model 32.

The conversion unit 34 converts the energy function of the conservation system into a curve (elliptic curve or hyperbola) function format. The curve may or may not include a power supply.

The feedback unit 35 linearizes the elliptic curve, for example, near the origin or calculates a non-linear asymptote of the hyperbola. The feedback unit 35 performs feedback control of a set of eigenvalue vectors or the asymptote that has been linearized as convergent/divergent components of the model 32.

The control unit 36 generates a control value, a control instruction, or a drive signal using the convergent/divergent components that have been fed back.

The output unit 37 outputs the control value, the control instruction, or the drive signal to the robot 2.

The storage unit 38 stores programs, thresholds, equations, and the like used by each unit of the control device 3.

### [Height-Variable Inverted Pendulum Model]

Next, a height-variable inverted pendulum model used in this embodiment will be described.

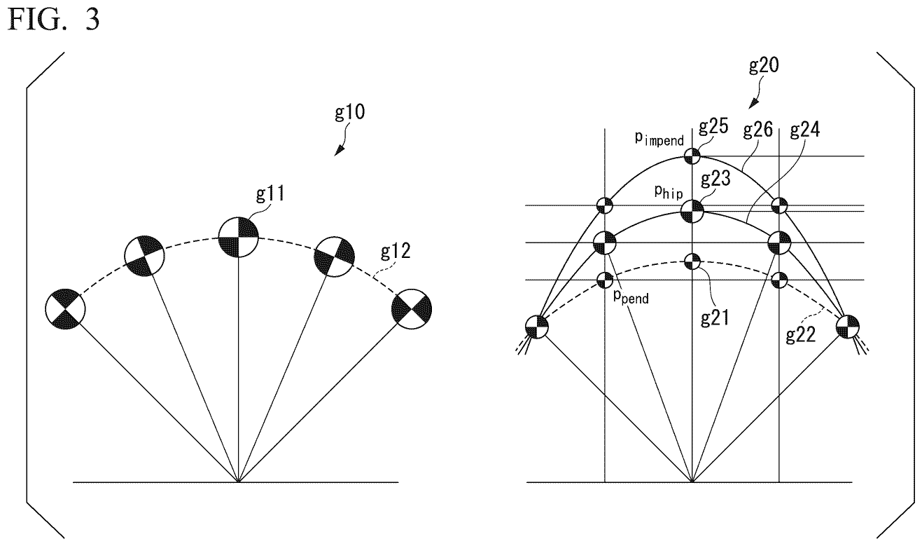

FIG. 3 is a diagram for describing a height-fixed inverted pendulum model and a height-variable inverted pendulum model.

An image g10 is a diagram illustrating a trajectory of the center of gravity according to the height-fixed inverted pendulum model. Center of gravity g11 is illustrated, and dotted line g12 represents a trajectory. Like the dotted line g12, in the case of a height-fixed inverted pendulum model, the trajectory becomes a trajectory moving on an outer circumference of a circle.

An image g20 is a diagram illustrates a trajectory of the center of gravity according to a height-variable inverted pendulum model according to this embodiment. Circle g21 represents a point mass p_{pend}, and dotted line g22 represents a trajectory of the point mass p_{pend}. Circle g23 represents the center of gravity of a waist and a position pₕᵢₚ thereof, and dotted line g24 represents a trajectory of the center of gravity pₕᵢₚ of the waist. Circle g25 represents a mass point and a position p_{impend} thereof, and dotted line g26 represents a trajectory of the mass point p_{impend}.

In this embodiment, like the image g20 illustrated in FIG. 3, by actively changing the height, effective control is performed.

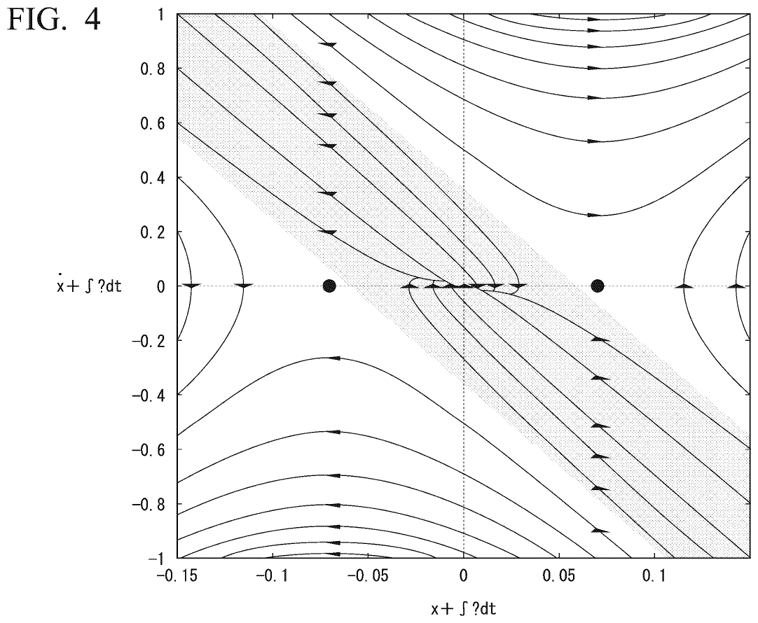

Control with a divergent component of a height-variable inverted pendulum model considered has been proposed (see Non-Patent Document 1). However, in such a conventional technology, since an analyzable phase plot cannot be drawn due to the presence of an integral term (3g∫·dx) as in a conservation energy function of the following Equation (1), and the vertical axis and the horizontal axis change constantly over time as illustrated in FIG. 4, it is difficult to obtain an analytical solution, and a control input is determined through iterative calculation (repetitive calculation) such as Model Predictive Control (MPC) or Sequential Quadratic Programming (SQP). FIG. 4 is an image diagram of a phase plot obtained in a case in which a divergent component of a height-variable inverted pendulum model is considered using a conventional technology. An arrow of each curve illustrates a way in which a position and a velocity of the center of gravity on a phase plane change after a minimal time. In Equation (1), x_{G} is the position of a center of mass (COM) in the x-axis direction, and h(x_{G}) and f(x_{G}) are functions of x_{G}.

$$E ( {x}_{G} , {\dot{x}}_{G} ) = \frac{1}{2} {\dot{x}}_{G}^{2} {h}^{2} ( {x}_{G} ) + {gx}_{G}^{2} f ( {x}_{G} ) - 3 g {\int }_{0}^{{x}_{G}} f ( x ) xdx \qquad ( 1 )$$

### [Linearization of Divergent Component and Convergent Component]

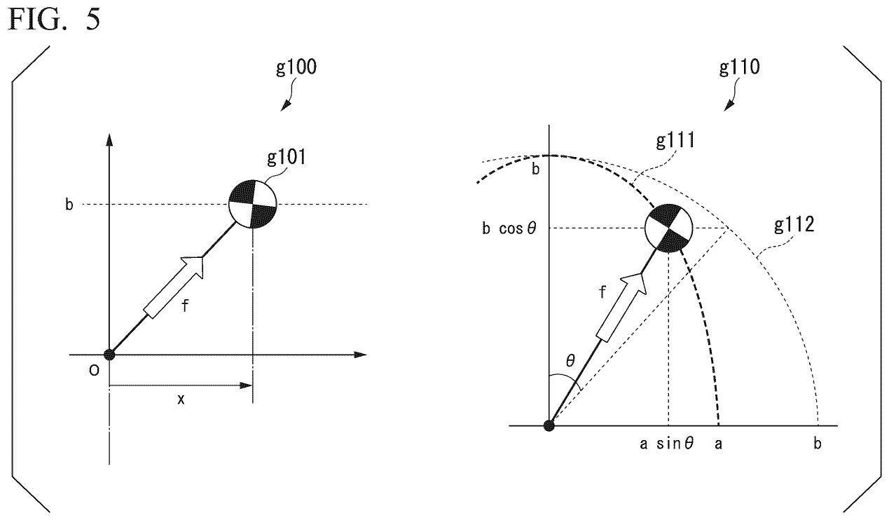

Next, linearization of a divergent component and a convergent component will be described. FIG. 5 is a diagram for describing linearization of a divergent component and a convergent component.

A diagram g100 is a height-fixed inverted pendulum model of a conventional technology. Point O is a pivot point, x is a position in the x-axis direction, b is a height in the y-axis direction, and f is a leg force. In this case, in order to maintain the height to be constant using the leg force f, a state vector is represented in the following Equation (2).

$$\frac{d}{dt} [ \begin{matrix}x \\ \dot{x}\end{matrix} ] = [ \begin{matrix}0 & 1 \\ {ω}^{2} & 0\end{matrix} ] [ \begin{matrix}x \\ \dot{x}\end{matrix} ] \qquad ( 2 )$$

The divergent component and the convergent component are a set of eigenvectors for which xθ^{⋅}=λx. λ is represented as in the following Equation (3).

$$λ = \pm ω = \pm \sqrt{\frac{g}{b}} \qquad ( 3 )$$

As in Equations (2) and (3), a solution of a height-fixed inverted pendulum model of a conventional technology cannot be obtained unless it is a linear system.

### First Example

In contrast to this, in this embodiment, like an image g110 illustrated in FIG. 5, an ellipse g111 for which x=x(θ) and y=y(θ) in accordance with the leg force f is drawn. In this example, an example in which the trajectory of the center of gravity is an ellipse or a hyperbola will be described. Since the height of the center of gravity is variable, here, it is assumed that the trajectory of the center of gravity rides on the ellipse. Dotted line g112 is a curve in the case of a perfect circle. θ is a state quantity of the inverted pendulum expressed in a parametric variable.

Here, under conditions of (a·sin(θ), b·cos(θ)) (ellipse), (a·sin h(θ), b·cos h(θ), and the like, the following Equation (4) is satisfied. In the conditions, a is a constant value, and α is a constant value in the image g110 illustrated in FIG. 5. θ is an angle formed between the y-axis (the vertical direction) and the leg force f.

$$\ddot{θ} = \frac{g}{C} x ( θ ) \qquad ( 4 )$$

C is a divergent component denominator variable and is expressed as y(δx/δθ)·x(δx/δθ). Particularly, in a case in which parametric variable display is performed as in ellipse p=[x, y]^{T} (here, T is transpose)=A[e^{c30}, e^{-c30}]T (c3 in the equation is c₃) or a hyperbola p=A[sin hθ, cos hθ]_{T}, C becomes a constant, and the value thereof becomes −2|A|c₃. A is a matrix with around ten rows/columns having complex numbers as its components, and c₃ is a constant that includes a complex number. Also in the case of a linear trajectory p=A|θ+hₓ, h_{y}|, p=A|θ+hₓ, θ+h_{y}|, or the like, C becomes a constant, and each thereof becomes h_{y} and h_{y}−hₓ.

In addition, linearization is performed around (θ, θ^{⋅})=(0, 0).

By approximating Equation (4) as the following Equation (5), Equation (2) becomes the following Equation (6).

$$\frac{g}{C} x ( θ ) \approx {ω}^{′2} θ \qquad ( 5 )$$

$$\frac{d}{dt} [ \begin{matrix}θ \\ \dot{θ}\end{matrix} ] = [ \begin{matrix}0 & 1 \\ {w}^{′2} & 0\end{matrix} ] [ \begin{matrix}θ \\ \dot{θ}\end{matrix} ] \qquad ( 6 )$$

From Equation (6), a set λ of eigenvalue vectors becomes as in the following Equation (7). This set of eigenvectors is a divergent component and a convergent component.

$$λ = \pm {ω}^{′} \qquad ( 7 )$$

In this case, although linear approximation can be performed near (q, q^{⋅})=(0, 0), when the position becomes far therefrom, approximation cannot be performed.

### [Stabilization Control of Walking Robot]

Here, a control system of a walking robot will be schematically described.

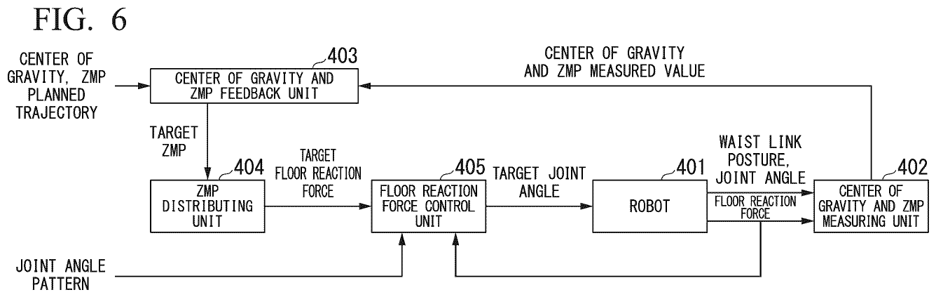

FIG. 6 is a schematic block diagram of a stabilization control system. As illustrated in FIG. 6, the stabilization control system of a walking robot, for example, includes blocks of a robot 401, a center of gravity and ZMP measuring unit 402, a center of gravity and ZMP feedback unit 403, a ZMP distributing unit 404, and a floor reaction force control unit 405.

The robot 401 is a bipedal walkable robot having sensors.

The center of gravity and ZMP measuring unit 402 calculates and obtains a ZMP and the center of gravity also following detection results (a waist link posture, a floor reaction force, and a joint angle) detected by the sensors of the robot 401.

The center of gravity and ZMP feedback unit 403 calculates a target ZMP on the basis of a center of gravity ZMP plan trajectory included in an instruction value and the center of gravity and the ZMP based on actual measurement values of the robot 401.

The ZMP distributing unit 404 converts the target ZMP into a target floor reaction force.

The floor reaction force control unit 405 calculates a target joint angle using inverse kinematics on the basis of a joint angle pattern included in the instruction value and the target reaction force and controls the operation of the robot 401.

See Reference Document 1 for details of each process, calculation methods, and the like.

In a usable state, by performing control on the basis of an instruction value, the robot 401 can be caused to walk. However, in reality, the robot 401 falls due to presence of regularities and the like or the like on the floor. For this reason, in order to stably control the robot 401, it is necessary to perform control by correcting the instruction value using (feeding back) detection results acquired by the sensors included in the robot 401.

### [Stabilization Control of Inverted Pendulum Model]

Next, stabilization control of an inverted pendulum model will be described.

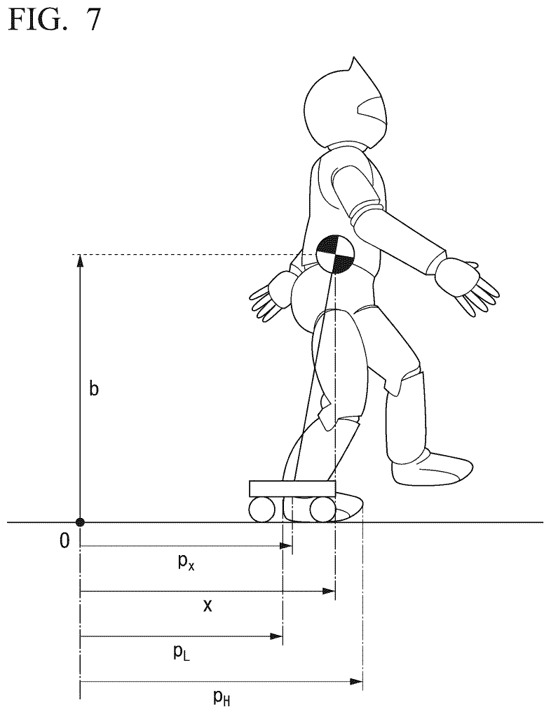

FIG. 7 is a diagram for describing symbols used in a state equation of an inverted pendulum. pₓ is the position of a pivot point in the x-axis direction, pL is an end position of the heel end of the foot, pH is an end position of the tip of the toe, and b is a height from the floor (foot sole) to the center of gravity. FIG. 7 illustrates an inverted pendulum model mounted in a cart. A state equation of the inverted pendulum can be represented using the following Equation (8).

$$\frac{d}{dt} [ \begin{matrix}x \\ \dot{x}\end{matrix} ] = [ \begin{matrix}0 & 1 \\ {ω}^{2} & 0\end{matrix} ] [ \begin{matrix}x \\ \dot{x}\end{matrix} ] + [ \begin{matrix}0 \\ - {ω}^{2}\end{matrix} ] {p}_{x} \qquad ( 8 )$$

In Equation (8), pₓ is an ZMP input and is stabilized by the following Equation (9). K_{P} and K_{V} are gains.

$${p}_{x} = {K}_{P} x + {K}_{V} \dot{x} \qquad ( 9 )$$

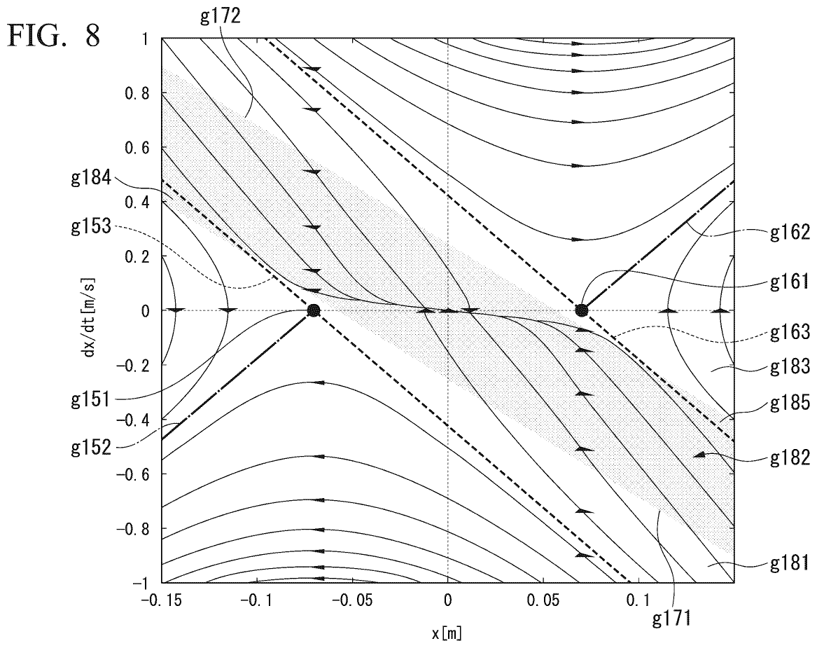

In this equation, since a ZMP constraint is present, a phase plot of the inverted pendulum is as illustrated in FIG. 8, and FIG. 8 is a phase plot obtained when stabilization control is performed by appropriately determining k_{P} and K_{V}.

Dotted lines g152 and g162 represent divergent components. Dotted lines g153 and g163 represent convergent components. The slopes of the divergent components and the convergent components are ω. Point g151 represents pL, and Point g161 represents pH. Dotted lines g152, g153, g162, and g163 dividing areas will be referred to as division lines.

An input of Line g171 is pL=K_{P}x+K_{V}x^{⋅}. The slope is −Kₚ/K_{V}. An input of Line g172 is pH=K_{P}x+K_{V}x^{⋅}.

Area g181 surrounded by Line g171 and Dotted line g153 is a convergent area.

Area g182 surrounded by Line g171 and Line 172 is an area in which the input is not saturated.

Ares g183 is an area in which the input is saturated.

Area g184 surrounded by Dotted line 153 and Line 171 is an area that cannot be stabilized even when it starts from an area in which the input is not saturated.

Area g184 surrounded by Dotted line 163 and Line 172 is an area that cannot be stabilized even when it starts from an area in which the input is not saturated.

Saturation represents a state in which an arrow-attached curve, for example, exhibits a change of a parabola or the like and does not converge to the origin. For this reason, in FIG. 8, Area g182 is a controllable area (control-possible area), and the other areas are saturated area. The example illustrated in FIG. 8 is an example in which the slope of the controllable area and the slope of the division lines (the asymptotes g153 and g163) do not coincide with each other.

In control in which a divergent component is fed back, K_{P} and K_{V} satisfy the following Equation (10).

$$\frac{{K}_{P}}{{K}_{V}} = ω ( {K}_{V} = \begin{matrix}{K}_{P} \\ ω\end{matrix} ) \qquad ( 10 )$$

When Equation (12) is substituted into Equation (11), pₓ becomes as in the following Equation (11), and (x+x^{⋅}/x) is a divergent component.

$${p}_{x} = {K}_{P} x + \frac{{K}_{P}}{ω} \dot{x} = {K}_{P} ( x + \frac{\dot{x}}{x} ) \qquad ( 11 )$$

In control in which a divergent component is fed back, there are advantages as below.
I. An optimal regulator in the sense that a stabilization margin can be maximized
II. The stabilization limit can be analytically calculated.

For example, in the case of a bipedal robot, it can be used for determining a timing for taking a step forward to avoid falling. In riding assist, it can be applied to assess the risk of falling.

However, as described above, in a conventional technology, in a case in which the height is configured to be variable, the axis changes constantly over time, and thus it is difficult to define a divergent component of a general inverted pendulum. For a height-variable inverted pendulum model, for example, see Non-Patent Document 1 and Reference Documents 2 and 3.

Reference Document 2; Caron Stephane, “Biped Stabilization by Linear Feedback of the Variable-Height Inverted Pendulum Model”, IEEE Conference Proceedings, IEEE, 2020

Reference Document 3; Garcia-Chavez G., “A Control Approach for the Variable-Height Inverted Pendulum Based on Sliding Mode Control With Input Saturation”, IEEE Conference Proceedings, IEEE, 2019

For this reason, in this embodiment, a curve (FIG. 5) of which the state quantity is a parametric variable space (for example, θ) and which becomes x=x(θ) and y=y(θ) in accordance with the leg force f is caused to be drawn, and linearization of a divergent component and a convergent component is performed. This curve is a line obtained by acquiring a conservation energy function of the model 32 using the function calculating unit 33 and converting the conservation energy function into a hyperbolic function format using the conversion unit 34.

In the case of this feedback control, as represented in Equation (5), the slope ω is constant.

### Process Sequence Example

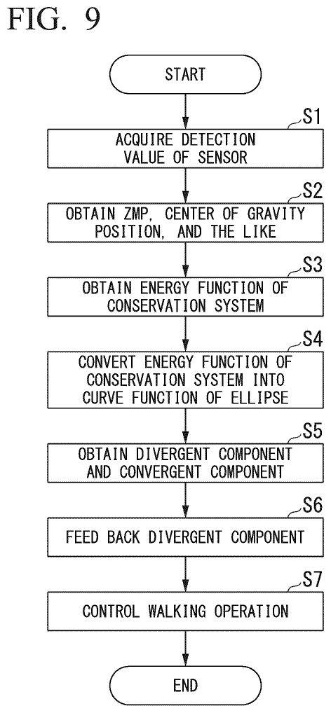

Next, an example of a process sequence performed by the control device 3 will be described. FIG. 9 is a flowchart of a process performed by the control device according to this embodiment.

(Step S1) The acquisition unit 31 acquires a detection result output by the robot 2.

(Step S2) The function calculating unit 33 acquires a ZMP position, a center of gravity position, and the like using the acquired detection result.

(Step S3) The function calculating unit 33 calculates an energy function of the conservation system using the ZMP position, the center of gravity position, and the like that have been acquired and the model 32.

(Step S4) The conversion unit 34 converts the energy function of the conservation system, for example, into a curve function format of an ellipse. The curve function is not limited to the ellipse and may be any shape other than a perfect circle of which the height is variable.

(Step S5) The feedback unit 35 calculates a divergent component and a convergent component (Equation (6)).

(Step S6) The feedback unit 35 performs feedback control of the divergent component and the convergent component as a convergent component/a divergent component of the model 32.

(Step S7) The control unit 36 generates a control value or a control instruction or a drive signal using the convergent component/divergent component that have been fed back. The control unit 36 outputs the control value or the control instruction or the drive signal to the robot 2 through the output unit 37.

The process illustrated in FIG. 9 is one example but is not limited thereto. For example, parts of the process may be performed in parallel with each other.

As described above, in this embodiment, the slope ω is constant, the state quantity is a task base (for example, x, y, and z coordinates), and walking is controlled using a height-variable inverted pendulum model.

In this embodiment, the slope ω is constant, the state quantity is a parametric variable space (for example, θ), and walking is controlled using a height-variable inverted pendulum model.

As described above, according to this embodiment, also for a height-variable non-linear inverted pendulum, a technique for deriving a divergent component from an energy function and stabilization control using the technique can be realized without performing iterative calculation unlike a conventional technology.

In a conventional technology, in order to acquire an analytical solution of a divergent component, the trajectory needs to be generated using a piecewise linearization model.

In contrast to this, according to this embodiment, the trajectory of the center of gravity is represented, for example, using an equation of an ellipse without generating the trajectory using a piecewise linearization model and is approximated by performing linearization near the origin of the phase plot, whereby an analytical solution that is a divergent component and a convergent component can be acquired.

### Second Example

### [Generalization of Divergent Component and Convergent Component]

In the example described above, although an example in which the slope ω is constant has been described, the slope ω is generalized to be variable in the following example.

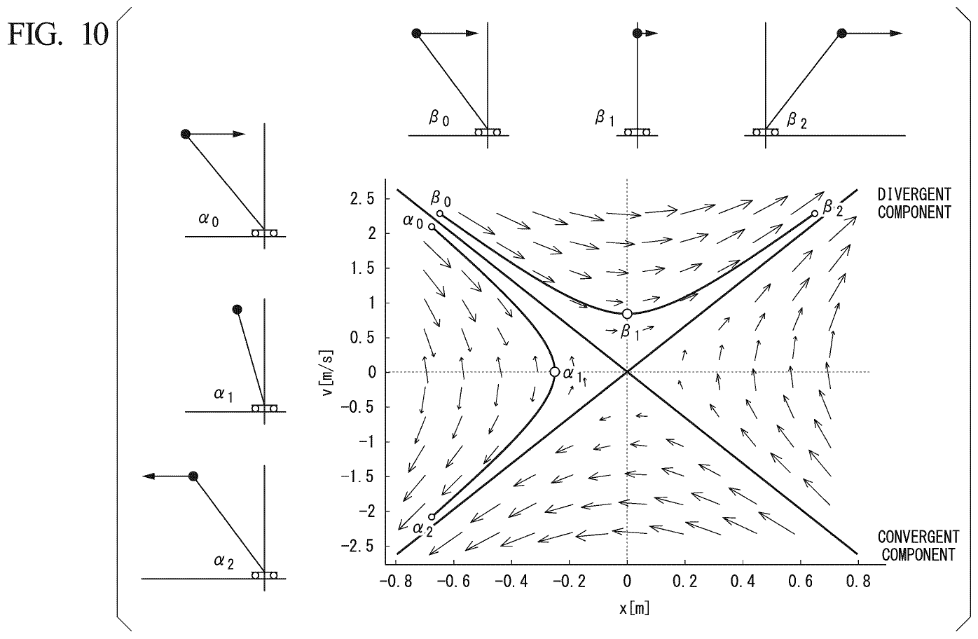

As illustrated in FIG. 10, in a case in which it is a conservation system even when it is a non-linear system, a convergent component and a divergent component can be acquired using an equation of energy. FIG. 10 is a diagram illustrating an example of a phase plot of a non-linear system. For this reason, in the following example, a divergent component is acquired in the format of energy.

First, the following Equation (12) of energy conservation will be focused. y is a center of gravity height.

$$\frac{1}{2} {\dot{x}}^{2} - \frac{g}{2 y} {x}^{2} = Constant ≡ E \qquad ( 12 )$$

By converting Equation (12) into a hyperbolic format, the following Equation (13) is obtained.

$$\frac{{\dot{x}}^{2}}{2 E} - \frac{{x}^{2}}{\frac{2 y}{g} E} = 1 \qquad ( 13 )$$

An asymptote (a division line) x of the hyperbolic format (13) is represented in the following Equation (14). As described above, since the asymptote x^{⋅} is a set of eigenvalue vectors as described above, it corresponds to a divergent component and a convergent component.

$$\dot{x} = \pm \sqrt{\frac{g}{y}} x = \pm ω x \qquad ( 14 )$$

In the case of being away from (q, q^{⋅})=(0, 0), the divergent component of the non-linear system needs to be obtained more accurately for the example described above. For this reason, here, if X(q)=∫s(q)dq when q^{⋅⋅}=(g/c)·x(q), the equation of the energy conservation can be converted into the following Equation (15), and, it can be converted into the following Equation (16) by converting Equation (15) into a hyperbolic format. Here, C is a constant.

$$\frac{1}{2} {\dot{θ}}^{2} - \frac{g}{2 C} X ( θ ) = E \qquad ( 15 )$$

$$\frac{1}{2 E} {\dot{θ}}^{2} - \frac{g}{\frac{2 C {θ}^{2}}{gX ( θ )}} {θ}^{2} = E \qquad ( 16 )$$

The asymptote θ^{⋅}(g201, g203) of the hyperbolic format (16) is the following Equation (17). Here, Ω(θ) is √(⋅)θ. Line g201 is an asymptote of the divergent component, and Line g203 is an asymptote of the convergent component.

$$\dot{θ} = \pm \sqrt{\frac{gX ( θ )}{C {θ}^{2}}} θ = \pm Ω ( θ ) x \qquad ( 17 )$$

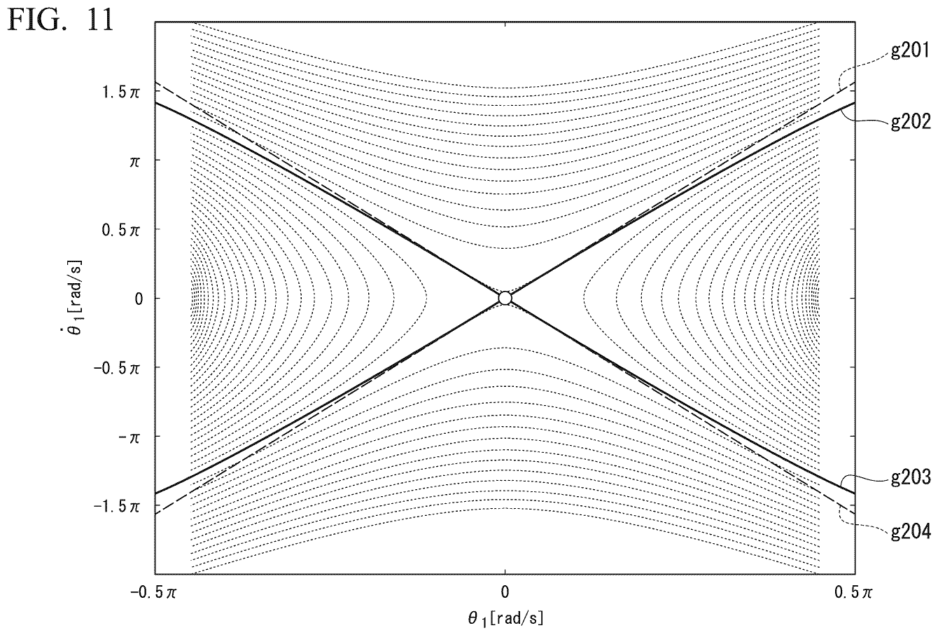

FIG. 11 is a phase plot in which the horizontal axis is θ₁ (rad/s), and the vertical axis is θ^{⋅}₁ (rad/s). In FIG. 11, asymptotes g202 and g204 are linearized.

The state equation of the inverted pendulum in Equation (15) can be represented as in the following Equation (18) using the image g110 illustrated in FIG. 5.

$$\frac{d}{dt} [ \begin{matrix}θ \\ \dot{θ}\end{matrix} ] = [ \begin{matrix}\dot{θ} \\ \frac{g}{b} sin θ\end{matrix} ] + [ \begin{matrix}0 \\ - {ω}^{2}\end{matrix} ] {τ}_{θ} \qquad ( 18 )$$

τ_{θ} is an input and is stabilized as τ_{θ}=K_{P}θ+K_{V}θ.

Here, in this embodiment, an input constraint of the following Equation (19) is applied.

$${τ}_{θ} = \{ \begin{matrix}{τ}_{L} & ( {K}_{P} θ + {K}_{V} \dot{θ} > {τ}_{L} ) \\ {K}_{P} θ + {K}_{V} \dot{θ} & ( {τ}_{L} < {K}_{P} θ + {K}_{V} \dot{θ} < {τ}_{H} ) \\ {τ}_{H} & ( {K}_{P} θ + {K}_{V} \dot{θ} < {τ}_{H} )\end{matrix} \qquad ( 19 )$$

### [Assessment]

Next, results of assessments of the above-described case in which linearization is performed near (q, q^{⋅})=(0, 0) (here, for example, q is θ) and a case in which a gain is set using a non-linear divergent component through a simulation will be described. In the simulation, a non-linear inverted pendulum model having a flywheel is used.

Here, an input the of a case in which linearization is performed near (q, q^{⋅})=(0, 0) (here, for example, q is θ) is as in the following Equation (20). An input τ_{θ} of a case in which a gain is set using a non-linear divergent component is as in the following Equation (21).

$${τ}_{θ} = {K}_{P} θ + {K}_{V} \dot{θ} = {K}_{P} ( θ + \frac{1}{ω} \dot{θ} ) \qquad ( 20 )$$

$${τ}_{θ} = {K}_{P} θ + {K}_{V} \dot{θ} = {K}_{P} ( θ + \frac{1}{Ω ( θ )} \dot{θ} ) \qquad ( 21 )$$

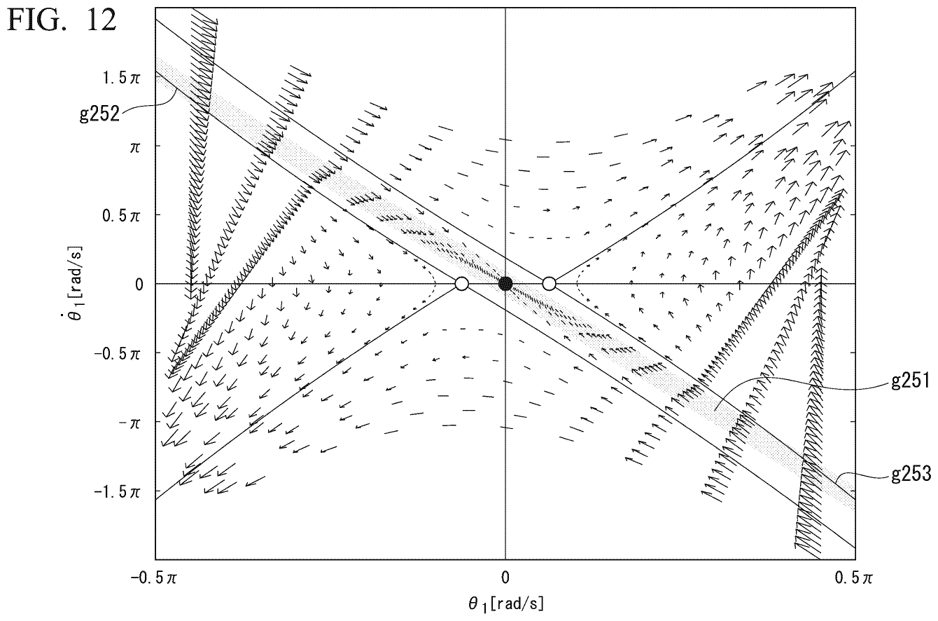

FIG. 12 is a diagram illustrating an example of a phase plot obtained in a case in which linearization is performed near (θ, θ^{⋅})=(0, 0) in accordance with this embodiment. The horizontal axis and the vertical axis are similar to those illustrated in FIG. 11. The example illustrated in FIG. 11 is an example in which the slope of a controllable area and the slope of a division line (an asymptote) coincide with each other.

In this case, as in FIG. 12, near (θ, θ^{⋅})=(0, 0), an area in which the input is not saturated enters Area g251 that can be stabilized. However, near a position at which θ₁ is near −0.5π, an area in which the input is not saturated protrudes from an area that can be stabilized (reference sign g252). Near a position at which θ₁ is near 0.5π, an area in which the input is not saturated protrudes from an area that can be stabilized (reference sign g253). In this way, in a case in which linearization is performed near (θ, θ^{⋅})=(0, 0), a non-linear shallow can be controlled such that it is stabilized within a predetermined range.

In accordance with this, according to this embodiment, an analytical solution of an energy equation can be obtained with the amount of calculation decreased to be less than that of a conventional technology.

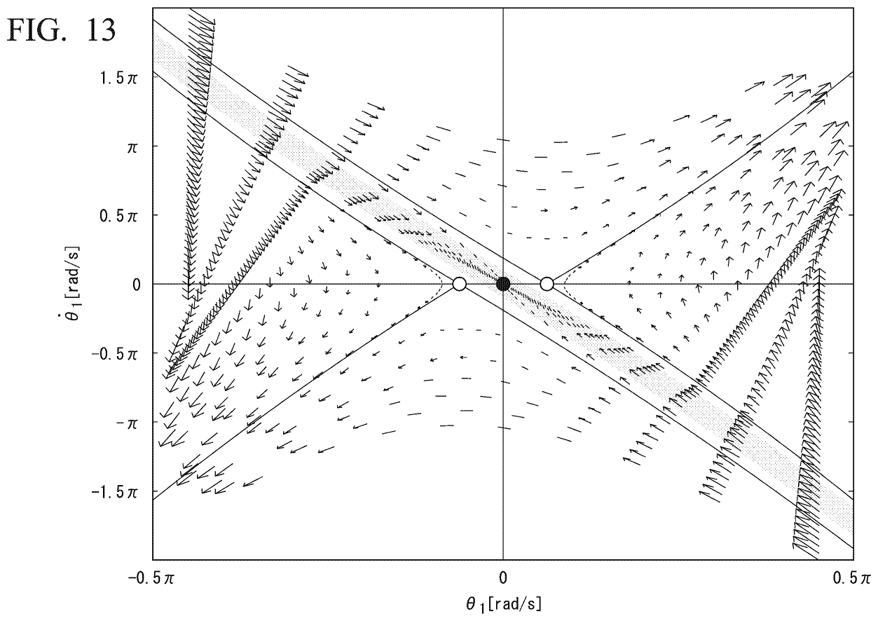

FIG. 13 is a diagram illustrating an example of a phase plot obtained in a case in which a gain is set using a non-linear divergent component according to this embodiment. The horizontal axis and the vertical axis are similar to those illustrated in FIG. 11. The example illustrated in FIG. 13 is an example in which the slope of a controllable area and the slope of a division line (an asymptote) coincide with each other.

In this case, as in FIG. 13, near (θ, θ^{⋅})=(0, 0) and in a case in which θ₁ is near-0.5π and near 0.5π, an area in which the input is not saturated enters an area that can be stabilized. In this way, in a case in which a gain is set using a non-linear divergent component, control can be performed with being stabilized in a wide input range.

According to this embodiment, by using the assessment, it has been checked that stabilization control can be performed robustly for an arbitrary trajectory by performing general energy feedback control for a non-linear inverted pendulum model having a flywheel using a ZMP input.

This embodiment can be applied also to a case in which non-linearity is strong. According to this embodiment, although a divergent component is changed in accordance with an angle, iterative calculation is unnecessary, and an analytical solution of an energy equation can be acquired.

### Process Sequence Example

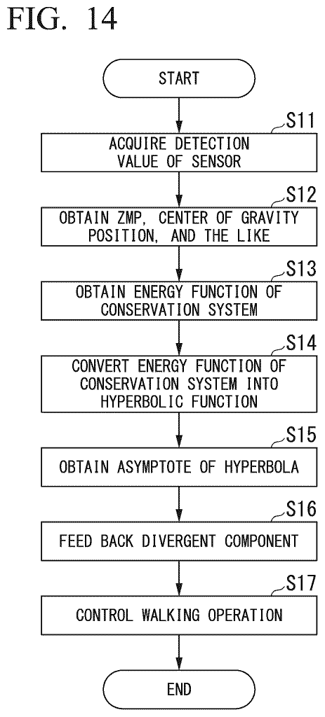

Next, an example of a process sequence performed by the control device 3 will be described. FIG. 14 is a flowchart of a process performed by the control device according to this embodiment.

(Step S11) The acquisition unit 31 acquires a detection result output by the robot 2.

(Step S12) The function calculating unit 33 acquires a ZMP position, a center of gravity position, and the like using the acquired detection result.

(Step S13) The function calculating unit 33 calculates an energy function of the conservation system using the ZMP position, the center of gravity position, and the like that have been acquired and the model 32.

(Step S14) The conversion unit 34 converts the energy function of the conservation system into a hyperbolic function format.

(Step S15) The feedback unit 35 calculates an asymptote (division line) of the hyperbola.

(Step S16) The feedback unit 35 performs feedback control using the asymptote as a convergent component/a divergent component of the model 32.

(Step S17) The control unit 36 generates a control value or a control instruction or a drive signal using the convergent component/divergent component that have been fed back. The control unit 36 outputs the control value or the control instruction or the drive signal to the robot 2 through the output unit 37.

In this embodiment, the slope w is constant, the state quantity is a task base (for example, x, y, and z coordinates), and walking is controlled using a height-variable inverted pendulum model.

In this embodiment, the slope ω is variable, the state quantity is a parametric variable space (for example, θ), and walking is controlled using a height-variable inverted pendulum model.

As described above, according to this embodiment, also for a height-variable non-linear inverted pendulum, a technique for deriving a divergent component from an energy function and stabilization control using the technique can be realized without performing iterative calculation unlike a conventional technology.

In a conventional technology, in order to acquire an analytical solution of a divergent component, the trajectory needs to be generated using a piecewise linearization model. In contrast to this, according to this embodiment, by using a model that is able to derive a curved trajectory including a straight line, an analytical solution can be acquired without generating a trajectory using a piecewise linearization model.

In each embodiment described above, although the bipedal walkable robot 2 has been described as one example of a mobile body, a mobile body controlling the posture is not limited thereto. The control method according to the embodiment can be applied also to a case in which the mobile body, for example, is a two-wheeled vehicle (an electric bicycle, a motorcycle, or the like) or the like.

In addition, all or some of the processes performed by the control device 3 may be performed by recording a program used for realizing all or some of the functions of the control device 3 according to the present invention on a computer readable recording medium and causing a computer system to read and execute the program recorded on this recording medium. A “computer system” described here includes an OS and hardware such as peripheral devices. In addition, the “computer system” also includes a WWW system having a home page providing environment (or a display environment). A “computer-readable recording medium” represents a storage device including a portable medium such as a flexible disk, a magneto-optical disc, a ROM, or a CD-ROM, a hard disk built in a computer system, and the like. Furthermore, a “computer-readable recording medium” includes a server in a case in which a program is transmitted through a network such as the Internet or a communication line such as a telephone line or a device such as a volatile memory (RAM) disposed inside a computer system that serves as a client that stores a program for a predetermined time.

Alternatively, some or all of such constituent elements may be realized by hardware (a circuit unit; includes circuitry) such as a large scale integration (LSI) including an application specific integrated circuit (ASIC), a field-programmable gate array (FPGA), a graphics processing unit (GPU), and the like or may be realized by software and hardware in cooperation.

The program described above may be transmitted from a computer system storing this program in a storage device or the like to another computer system through a transmission medium or a transmission wave in a transmission medium. Here, the “transmission medium” transmitting a program represents a medium having an information transmitting function such as a network (communication network) including the Internet and the like or a communication line (communication wire) including a telephone line. The program described above may be used for realizing a part of the functions described above. In addition, the program described above may be a program realizing the functions described above by being combined with a program recorded in the computer system in advance, a so-called a differential file (differential program).

As above, although forms for performing the present invention have been described using the embodiments, the present invention is not limited to such embodiments at all, and various modifications and substitutions may be applied within a range not departing from the concept of the present invention.

What is claimed is:

1. A posture control method of a non-linear inverted pendulum model, of which a height of a center of gravity is variable, and a trajectory of the center of gravity is an energy conserving system, using a control device, the posture control method comprising:
obtaining a conservation energy function on the basis of a measured value of the center of gravity;
converting the conservation energy function into a curve function; and
calculating a set of eigenvectors through approximation as a convergent component and a divergent component without iterative calculation of a controllable area in a phase plot of the converted curve function and feeding back the convergent component and the divergent component that have been calculated.

2. The posture control method according to claim 1,
wherein the trajectory of the center of gravity is an ellipse or a hyperbola, and
wherein the control device linearizes the set of eigenvectors around the origin of a phase plot of the curve function of the ellipse and feeds back the linearized set of eigenvectors as a convergent component and a divergent component.

3. The posture control method according to claim 1,
wherein the curve function is a hyperbolic function, and
wherein the control device feeds back an asymptote of a curve drawn by the hyperbolic function as a convergent component and a divergent component of the non-linear inverted pendulum model.

4. The posture control method according to claim 1, wherein the conservation energy function is set using a parametric variable.

5. The posture control method according to claim 2, wherein the linearized set λ=±ω′ of eigenvectors that is the convergent component and the divergent component is obtained from the following equation:
$$\frac{d}{dt} [ \begin{matrix}θ \\ \dot{θ}\end{matrix} ] = [ \begin{matrix}0 & 1 \\ {ω}^{′2} & 0\end{matrix} ] [ \begin{matrix}θ \\ \dot{θ}\end{matrix} ] .$$

6. The posture control method according to claim 3,
wherein θ is a state quantity of an inverted pendulum expressed in a parametric variable, θ^{⋅} is a time derivative of θ, g is a gravitational acceleration, C is a divergent component denominator variable, X(θ) is a function, Ω(θ) is a function, and x is a position in a movement direction, and
wherein the asymptote is obtained using the following equation:
$$\dot{θ} = \pm \sqrt{\frac{gX ( θ )}{C {θ}^{2}}} θ = \pm Ω ( θ ) x .$$

7. The posture control method according to claim 2,
wherein K_{P} is a gain, K_{V} is a gain, θ is a state quantity of an inverted pendulum expressed in a parametric variable, θ^{⋅} is a time derivative of θ, τ_{θ} is an input to a system, and ω is a slope of the divergent component and is K_{P}/K_{V}, and
wherein the control device performs the feedback on the basis of the following equation:
$${τ}_{θ} = {K}_{P} θ + {K}_{V} \dot{θ} = {K}_{P} ( θ + \frac{1}{ω} \dot{θ} ) .$$

8. The posture control method according to claim 3,
wherein K_{P} is a gain, K_{V} is a gain, θ is a state quantity of an inverted pendulum expressed in a parametric variable, θ^{⋅} is a time derivative of θ, τ_{θ} is an input to a system, ω is a slope of the divergent component and is K_{P}/K_{V}, and Ω(θ) is a function of θ, and
wherein the control device performs the feedback on the basis of the following equation:
$${τ}_{θ} = {K}_{P} θ + {K}_{V} \dot{θ} = {K}_{P} ( θ + \frac{1}{Ω ( θ )} \dot{θ} ) .$$

9. A posture control device controlling a posture of a mobile body, the posture control device comprising:
a non-linear inverted pendulum model of which a height of a center of gravity is variable, and a trajectory of the center of gravity is an energy conserving system;
a function calculating unit obtaining a conservation energy function on the basis of a measured value of the center of gravity;
a conversion unit converting the conservation energy function into a curve function; and
a feedback unit calculating a set of eigenvectors through approximation as a convergent component and a divergent component without iterative calculation of a controllable area in a phase plot of the converted curve function and feeding back the convergent component and the divergent component that have been calculated.

10. A computer-readable non-transient storage medium storing a program causing a computer of a control device, which controls a posture of a mobile body, having a non-linear inverted pendulum model of which a height of a center of gravity is variable, and a trajectory of the center of gravity is an energy conserving system, to:
obtain a conservation energy function on the basis of a measured value of the center of gravity;
convert the conservation energy function into a curve function; and
calculate a set of eigenvectors through approximation as a convergent component and a divergent component without iterative calculation of a controllable area in a phase plot of the converted curve function and feed back the convergent component and the divergent component that have been calculated.
